(19) United States
(12) Patent Application Publication
(10) Pub. No.: US 2007/0078705 A1
(43) Pub. Date: Apr. 5, 2007

(54) Virtualizing portals for electronic commerce

(76) Inventors: Timothy Abels, Pflugerville, TX (US); Shannon Christopher Boesch, Austin, TX (US)

Correspondence Address: HAMILTON & TERRILE, LLP, P.O. BOX 203518, AUSTIN, TX, 78720, US

(21) Appl. No.: 11/239,897

(22) Filed: Sep. 30, 2005

(51) Int. Cl. G06Q 30/00

(52) U.S. Cl. 705/14

(57) ABSTRACT

A system and method is disclosed for a virtual portal (vPortal), that can logically front-end and generate personalized presentations of eCommerce electronic (e.g., web portal) or paper-based (e.g., catalog) content, based on individual or group preferences and/or predetermined authorizations, through the implementation of a local portal registry (pRegistry), editable by a user or third party (e.g., corporate customer purchasing department). The method of the invention can also generate target content, mapped to a subset of available source content (e.g., web portal or hardcopy print), such that the target content can be a predetermined superset of individual user-selectable preferences and/or predetermined authorizations, including but not limited to eCommerce content, advertisements, content metrics, and reporting.

### BACKGROUND OF THE INVENTION

1. Field of the Invention

The present invention relates in general to the field of information handling systems, and more specifically, to the delivery of personalized data content through an electronic commerce system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is processed, stored or communicated, an how quickly and efficiently the information may be processed, stored, or communicated. The variations in information handling systems allow for information handling systems to be general or configured for a specific user or specific use such as financial transaction processing, airline reservation, enterprise data storage, or global communications. In addition, information handling systems may include a variety of hardware and software components that may be configured to process, store, and communicate information, and may include one or more computer systems, data storage systems, and networking systems.

The use of web portals for electronic commerce (eCommerce) has become prevalent, due in part, to their ability to deliver personalized content to a viewer. Currently, web portals typically fall into one of two categories: physical or virtual.

Physical web portals typically operate as installation instances of an application server that runs in a virtual machine and works in conjunction with an assigned portal configuration database, all of which is implemented on information handling system hardware. One of the benefits of implementing these “true” servers is that applications and data can be isolated. Conversely, not being able to share applications and data between true portals can also be a disadvantage. Another potential disadvantage of this approach is the use of multiple virtual machines can also have an impact on memory consumption and, therefore, limit the number of true portals that can reside on the same hardware.

Virtual portals (vportal) are logical partitions within a single installation of a true portal and application server. Many such partitions are possible since this approach is highly scalable, and applications and data can be shared. Since vPortals can share the same applications and data, they are conducive for the implementation of customizable eCommerce portals. These portals can be configured for the predetermined needs of an individual, or a group of users. However, current implementations of vPortals can exhibit certain limitations.

For example, an eCommerce portal may use vendor cookies to customize the content presented to a viewer. As the name implies, these cookies are controlled by the vendor, not the user or a third party (e.g., a corporate customer), and as such, the viewer (or third party) typically has no control over what content is presented. The resulting interaction and user experience can be challenging, since the viewer has no way to avoid presentation of content that may be irrelevant, distracting, or even aggravating. For example, the viewer may have made a one-time purchase (e.g., a DVD player) only to have such products “showcased” upon every subsequent visit. Similarly, the viewer may have viewed an item one time during a prior visit, only to have the same item, and similar items, presented upon subsequent visits when there is no current interest in purchasing the item.

On the other hand, a viewer may have spent significant time searching for an item on an earlier visit, only to be unable to locate the same, or a similar, item during later visits. Other typical shortcomings of vendor cookies include a lack of relevancy, or the ability to avoid the presentation of irrelevant content categories (e.g., household appliances presented to an industrial buyer) which are often combined with repetitive pop-ups and animated or video advertisements that are time consuming to load and play. Conversely, a viewer is generally unable to receive customer-specific, relevant and/or proactive product notifications (e.g., discounts, sales, etc.). Furthermore, viewer preferences and/or predetermined authorizations at one eCommerce portal cannot be conveyed or reflected to other portals.

Accordingly, what is required is a vPortal approach that can deliver relevant and/or specific information, based on individual or group preferences and/or predetermined authorizations.

### SUMMARY OF THE INVENTION

In accordance with the present invention, a system and method is provided for a virtual portal (vportal) that can logically front-end and generate personalized presentations of eCommerce electronic (e.g., web portal) or paper-based (e.g., catalog) content, based on individual or group preferences and/or predetermined authorizations. Various embodiments of the invention can be implemented using a local portal registry (pRegistry) that is editable by a user or third party (e.g., corporate customer purchasing department). Furthermore, in various embodiments of the invention, a vPortal can also generate target content, mapped to a subset of available source content (e.g., web portal or hardcopy print), such that the target content can be a predetermined superset of individual user-selectable preferences and/or predetermined authorizations. The authorizations can include, but are not limited to, eCommerce content, advertisements, content metrics, and reporting.

Updates and mappings used in various embodiments of the invention may include, but are not limited to, changes to previous cache content, just-in-time browsing of presented content, pre-loaded product and order status notifications, and usage and reporting metrics. Furthermore, in various embodiments of the invention, pRegistry control of vPortal content presented to a user can be extended to predetermined system configurations including, but not limited to, security settings, software component downloads, and pre-checked warning boxes. In various other embodiments of the invention, the pRegistry can be implemented to allow vPortal-based, off-line browsing where websites can be pre-crawled and/or pre-loaded, based on content mapping matches between a vPortal and pRegistry user preferences and/or predetermined authorization controls.

As will be understood by those of skill in the art, the system and method of the present invention can be implemented in many ways including, but not limited to, user-specific and filtered Web content being automatically generated at eCommerce vPortals, cooperating peer portals, edge or border caching servers, or even by human operators. The human operators can be manually guided by pRegistry user preferences and/or predetermined authorizations. In addition, the content generation point can be set to accommodate specific content delivery constraints, based on the user preferences and/or predetermined authorizations contained in the pRegistry.

In various embodiments of the invention, cross-portal eCommerce notifications can be generated based on user-preference and/or predetermined authorizations relating to product availability, discounts, updates, promotions, bundles, etc. Similarly, in various embodiments of the invention, peer-to-peer versions of vPortals can be implemented to allow groups of cooperating consumers to aggregate purchases to attain group discounts. In this embodiment of the invention, the cooperation of the groups can be made undetectable by the other contributing vPortals.

Those of skill in the art will understand that many such embodiments and variations of the invention are possible, including but not limited to those described hereinabove.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the method and apparatus of the present invention.

FIG. 2 is a flowchart illustration of a virtual portal (vPortal) mapped to a physical, or “true”, portal for personalized presentation of eCommerce content.

FIG. 3 is a flowchart illustration of a vPortal mapped to a catalog for personalized presentation of eCommerce content in a variety of forms.

FIG. 4 is a flowchart illustration of the creation and/or update of vPortal web pages, for personalized presentation of eCommerce content.

FIG. 5 is a flowchart illustration of the creation and/or update of vPortal catalog pages, for personalized presentation of eCommerce content.

FIG. 6 is a flowchart illustration of an implementation of vPortal eCommerce transactions, as it relates to the personalized presentation of eCommerce content.

FIG. 7 is a flowchart illustration of an implementation of vPortal policy creation and/or update, as it relates to the personalized presentation of eCommerce content.

FIG. 8 is a generalized illustration of an implementation of a vPortal access control list.

FIG. 9 is a generalized illustration of an implementation of a vPortal product category access control list.

FIG. 10 is a generalized illustration of an implementation of a vPortal product information access control list.

### DETAILED DESCRIPTION

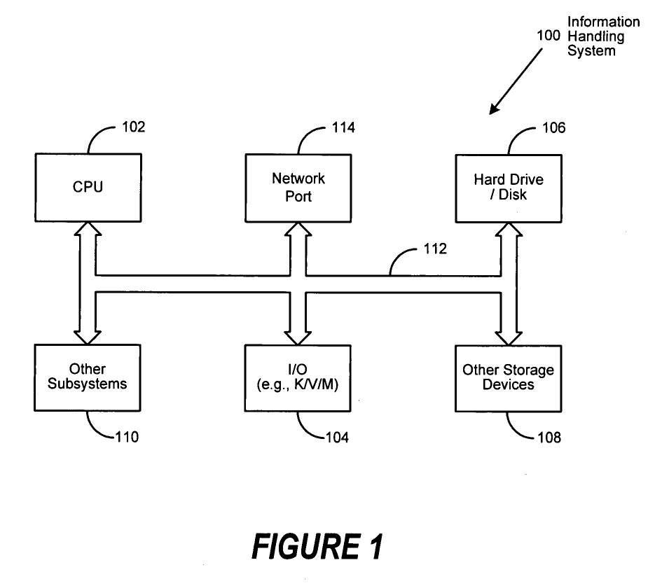

FIG. 1 is a generalized illustration of an information handling system 100 that can be used to implement the method and apparatus of the present invention. The information handling system includes a processor 102, input/output (I/O) devices 104, such as a display, a keyboard, a mouse, and associated controllers, a hard disk drive 106, other storage devices 108, such as a floppy disk and drive and other memory devices, various other subsystems 110, and network port 114, all interconnected via one or more buses 112.

For purposes of this disclosure, an information handling system may include any instrumentality or aggregate of instrumentalities operable to compute, classify, process, transmit, receive, retrieve, originate, store, display, manifest, detect, record, reproduce, handle, or utilize any form of information, intelligence or data for business, scientific, control or other purposes. For example an information handling system may be a personal computer, a network storage device, or any other suitable device and may vary in size, shape performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

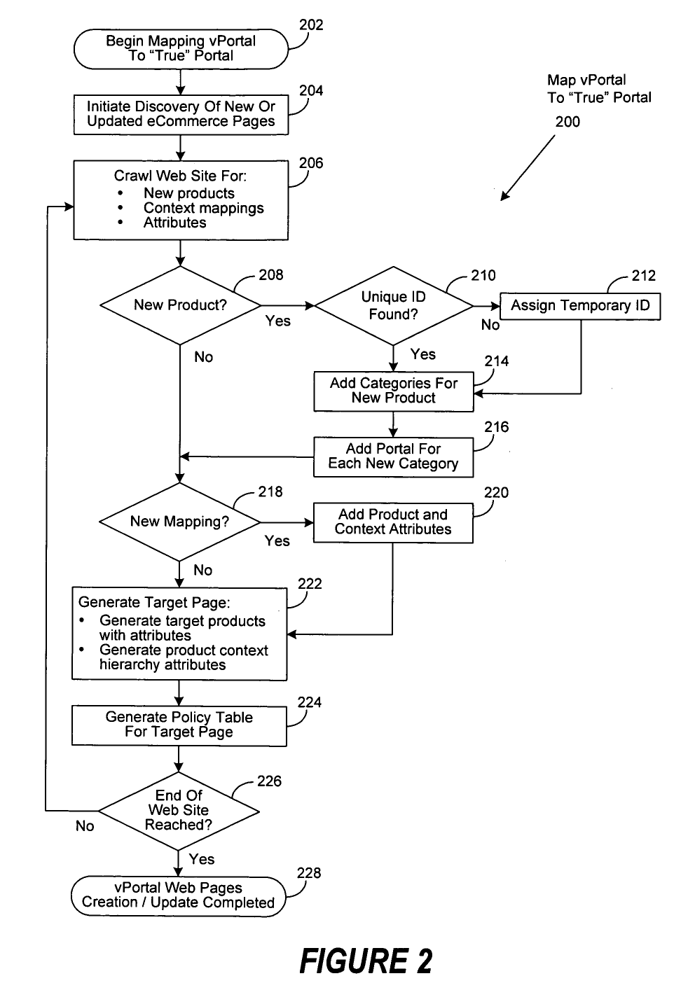

FIG. 2 is a flowchart illustration of an implementation of a virtual portal (vportal) 200 mapped to a physical, or “true,” portal for personalized presentation of eCommerce content in accordance with one embodiment of the present invention. As will be understood by those of skill in the art, the processing steps illustrated in FIGS. 2-8 can be implemented using an information handling system 110 illustrated in FIG. 1. In step 202, the mapping of a vPortal to the content of a physical, or “true” portal is initiated. In step 204 automated or manual discovery of new and/or updated eCommerce pages is initiated. In step 206, known root pages of the website are “crawled” (e.g., similar to a search engine “spider” ) for content, including but not limited to, new products and associated information, context mappings (e.g., product on a new page), attributes, etc.

Those of skill in the art will be appreciate that while a web site can be manually searched for specific content, the automated discovery of changes and/or updates of eCommerce content can be accomplished more easily through automated and ongoing web site “crawling”. In step 208, when a product is discovered on the web site, it is checked to see whether or not it is “new” (i.e., not previously discovered, described and/or and registered). Furthermore, a combination of manual and automated steps may need to take place for unknown and un-translated types of product content (e.g., file, mime, etc.) in combination with the steps described in more detail hereinbelow.

In step 210, an attempt is made to discover the unique ID (e.g., ISBN or SKU) of the “new” product. If, in step 210, it is determined the “new” product has no unique product ID, then a temporary ID is assigned in step 212. The “new” product's temporary ID can be regularly reviewed and, at a later time, the “new” product can be assigned a unique and permanent ID. In step 214 category attributes (e.g., book, DVD, laptop computer, printer, etc.) are added to each “new” product. In step 216 a portal is added for each new category.

If, in step 218 it is determined that the “new” product also requires a new mapping (e.g., the product's unique ID is not previously on this page) or attributes, then product and context attributes are added in step 220. In step 222 a target page is generated, based on a superset of user policies. Generation of the target page can include, but is not limited to, target products with their attributes, and a context hierarchy of products with associated context attributes.

In step 224 a policy table for the target page is generated, for rapid user policy filtering, (e.g., sorting, filtering-out undesired content, etc.). If, in step 226, the last product on the web site has not been mapped, then mapping continues with the next product encountered by crawling the web site as described hereinabove, beginning with step 206. Otherwise, the mapping of vPortal web pages to the physical, or “true”, portal is completed in step 228.

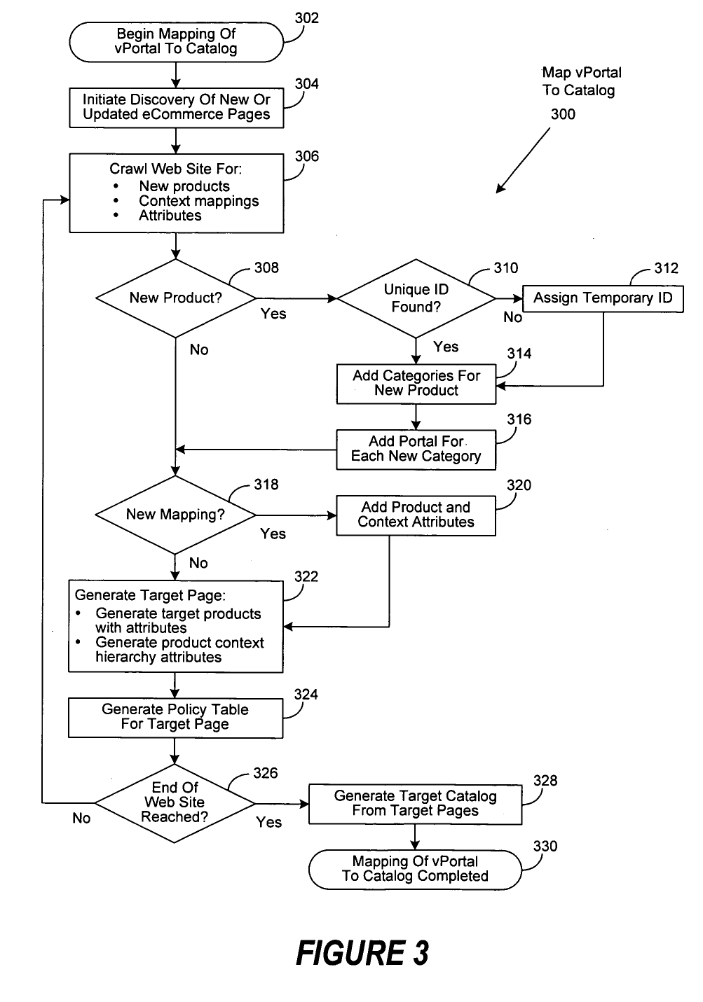

FIG. 3 is a flowchart illustration of an implementation of a vPortal mapped to a catalog 300 for personalized presentation of eCommerce content in a variety of forms in accordance with one embodiment of the present invention. In step 302, the mapping of a vPortal to the content of a catalog is initiated. Those of skill in the art will recognize that catalogs may take many electronic and physical forms and that various embodiments of the invention can be implemented for audio and video catalogs, printed advertisements and mailings, personalized CDs containing electronic content, etc.

In step 304 automated or manual discovery of new and/or updated eCommerce pages is initiated. In step 306, known root pages of the website are “crawled” (e.g., similar to a search engine “spider”) for content, including but not limited to, new products and associated information, context mappings (e.g., product on a new page), attributes, etc. Those of skill in the art will understand that while a web site can be manually searched for specific content, the automated discovery of changes and/or updates of eCommerce content can be accomplished more easily through automated and ongoing web site “crawling”.

In step 308, when a product is discovered on the web site, it is checked to see whether or not it is “new” (i.e., not previously discovered, described and/or and registered). Furthermore, a combination of manual and automated steps may need to take place for unknown and un-translated types of product content (e.g., file, mime, etc.) in combination with the steps described in more detail hereinbelow. In step 310, an attempt is made to discover the unique ID (e.g., ISBN or SKU) of the “new” product. If, in step 310, it is determined the “new” product has no unique product ID, then a temporary ID is assigned in step 312. Note that the “new” product's temporary ID can be regularly reviewed, and at a later time, the “new” product can be assigned a unique and permanent ID.

In step 314 category attributes (e.g., book, DVD, laptop computer, printer, etc.) are added to each “new” product. In step 316 a portal is added for each new category. If, in step 318 it is determined that the “new” product also requires a new mapping (e.g., the product's unique ID is not previously on this page) or attributes, then product and context attributes are added in step 320. In step 322 a target page is generated, based on a superset of user policies. Generation of the target page can include, but is not limited to, target products with their attributes, and a context hierarchy of products with associated context attributes.

In step 324 a policy table for the target page is generated, for rapid user policy filtering, (e.g., sorting, filtering-out undesired content, etc.). If, in step 326, the last product on the web site has not been mapped, then mapping continues with the next product encountered by crawling the web site as described hereinabove, beginning with step 306. Otherwise, if the last product on the web site has been mapped, then a target catalog is generated in step 328 from appropriate file types (e.g., html, XML, MIME, major formats for graphics). In step 328, mapping of vPortal web pages to a catalog is completed.

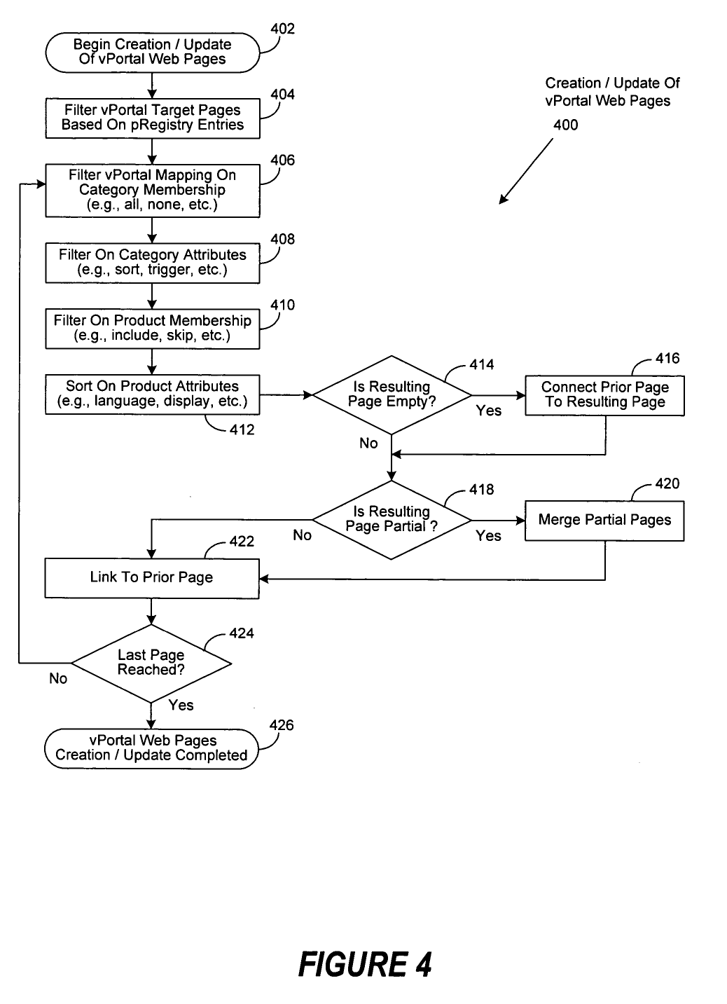

FIG. 4 is a flowchart illustration of an implementation of the creation and/or update of vPortal web pages 400, for personalized presentation of eCommerce content, in accordance with one embodiment of the present invention. In step 402, the creation and/or update of vPortal web pages is initiated. In step 404, target pages are filtered, based on entries in the personal registry (pRegistry) associated with the vPortal. In step 406, vPortal mapping is filtered on category membership (e.g., all, none, etc.). In step 408, vPortal content is filtered on category attributes (e.g., sort, trigger, etc.). In step 410, vPortal content is filtered on product membership (e.g., include, skip, etc.). In step 412, vPortal content is filtered on product attributes (e.g., language, display, etc.).

In step 414, if the resulting page is empty, then the resulting page is connected to the previous page in step 416. Otherwise, in step 418, if the resulting page is a partial page, per user display preferences and/or predetermined authorizations, then it is merged with other partial pages in step 420. In step 422, resulting pages, whether empty pages connected to a previous page or a partial page merged with other partial pages, they are in turn linked to the previous page. If, in step 424, the last page has not been reached, then creation and/or updating continues with the next page encountered as described hereinabove, beginning with step 406. If, in step 424, the last page has been reached, the creation and/or updating of web pages is completed in step 426. As will be understood by those of skill in the art, the creation and/or updating of web pages, as described hereinabove, are not limited to vPortals, but can also take place in an automated manner at physical or “true” portals, as well as through manual processes by a human user.

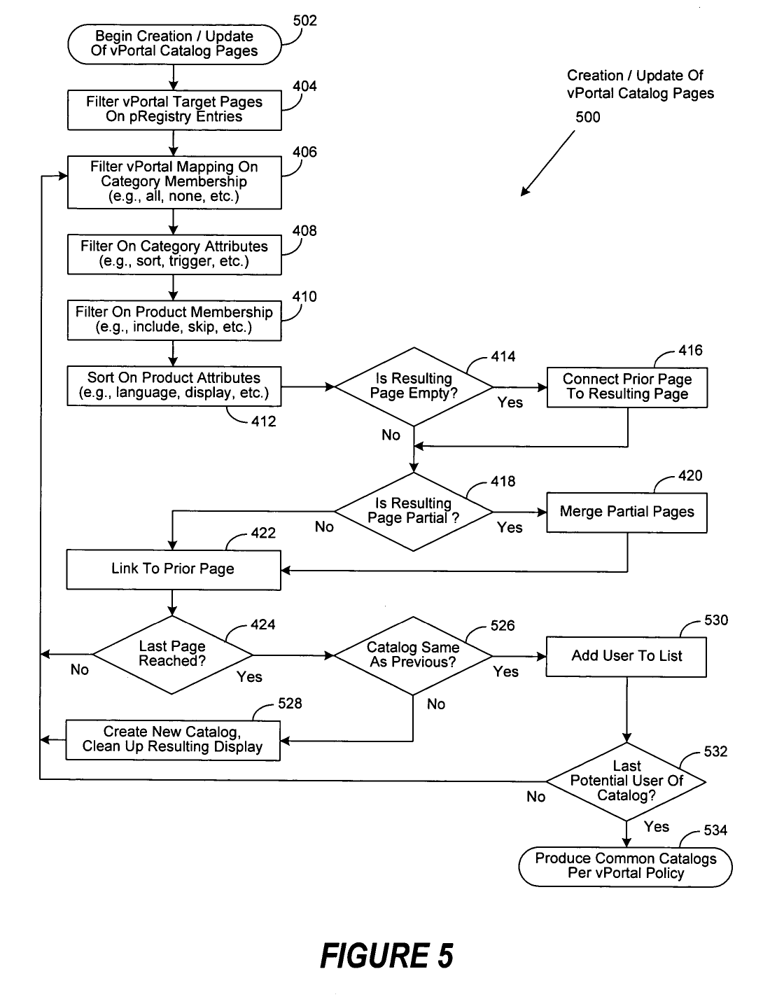

FIG. 5 is a flowchart illustration of an implementation of the creation and/or update of vPortal catalog pages 500, for personalized presentation of eCommerce content, in accordance with one embodiment of the present invention. In step 502, the creation and/or update of catalog pages, comprised of a vPortal's content, is initiated. Those of skill in the art will recognize that catalogs may take many electronic and physical forms, and that various embodiments of the invention could be implemented for audio and video catalogs, printed advertisements and mailings, personalized CDs containing electronic content, etc. In step 404, target pages are filtered, based on entries in the personal registry (pRegistry) associated with the vPortal. In step 406, vPortal mapping is filtered on category membership (e.g., all, none, etc.).

In step 408, vPortal content is filtered on category attributes (e.g., sort, trigger, etc.). In step 410, vPortal content is filtered on product membership (e.g., include, skip, etc.). In step 412, vPortal content is filtered on product attributes (e.g., language, display, etc.). In step 414, if the resulting page is empty, then the resulting page is connected to the previous page in step 416. Otherwise, in step 418, if the resulting page is a partial page, per user display preferences and/or predetermined authorizations, then it is merged with other partial pages in step 420. In step 422, resulting pages, whether empty pages connected to a previous page or a partial page merged with other partial pages, they are in turn linked to the previous page.

If, in step 424, the last page has not been reached, then creation and/or updating continues with the next page encountered as described hereinabove, beginning with step 406. Otherwise, if in step 526, the resulting catalog is not the same as the previous catalog, a new catalog is created, the resulting display is cleaned up per vPortal policies, and creation and/or updating continues with the next page encountered as described hereinabove, beginning with step 406. Otherwise, in step 530, the user is added to a list to receive that catalog.

If, in step 532, the last potential user of a catalog has not been reached, then creation and/or updating continues with the next page encountered as described hereinabove, beginning with step 406. Otherwise, in step 534, common catalogs are produced, per vPortal policy. As will be understood by those of skill in the art, the creation and/or updating of catalogs from vPortal content, as described hereinabove, are not limited to vPortals, but can also take place in an automated manner at physical or “true” portals, as well as through manual processes by a human user. Furthermore, production of common catalogs can be implemented in a batch process, based on machine availability and other factors. Likewise, unique catalogs can be produced on demand as needed, in a production run, locally or remotely. Those of skill in the art will understand that many such embodiments and variations of the invention are possible, including but not limited to those described hereinabove, which are by no means all inclusive.

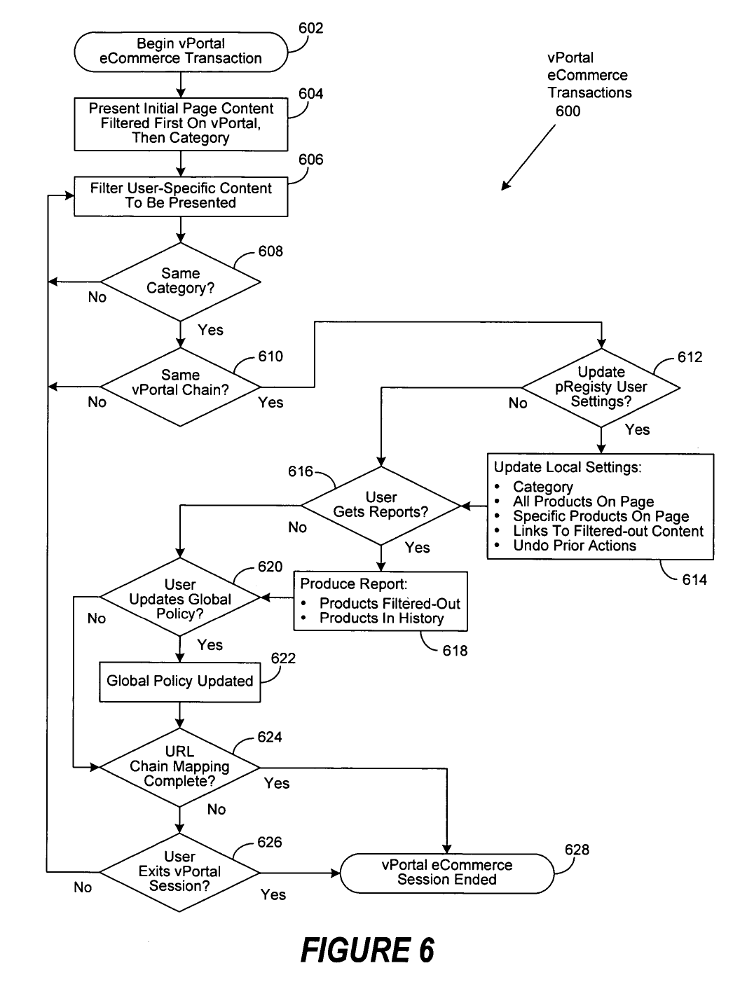

FIG. 6 is a flowchart illustration of an implementation of vPortal eCommerce transactions 600, for personalized presentation of eCommerce content, in accordance with one embodiment of the present invention. In step 602, an eCommerce transaction is initiated. In step 604, initial page content is presented to the user, filtered first on vPortal, and then by product category. In step 606, vPortal content is filtered to present pages of user-specific content. If, in step 608, user-specific content is encountered that is not in the same category, then filtering of vPortal content continues, as described hereinabove, beginning with step 606.

Otherwise, in step 610, if user-specific content is encountered that is not in the same vPortal chain, then filtering of vPortal content continues, as described hereinabove, beginning with step 606. Otherwise, in step 612, if pRegistry user settings need to be updated, then the user, or an authorized party, can update the local pRegistry in step 614. For example, in various implementations of an embodiment of the invention, product category attributes can be set (e.g., on, off, remove history, etc.). Likewise, one, some, or all products on page can be marked as “don't view again,” or conversely, links to filtered-out content can be set to manually override policy. Similarly, last actions can be undone, or any user action sequence back to the ultimate undo of entire history log, back to pRegistry defaults. Those of skill in the art will understand that many such embodiments and variations of the invention are possible, including but not limited to those described hereinabove, which are by no means all inclusive.

Otherwise, in step 616, if the user needs to get reports, then reports can be generated in step 618, for example, based on filtered-out content or products in viewing or purchase history. Otherwise, in step 620, if the user or authorized party needs to update global pRegistry policy, it can be updated in step 622. Otherwise, in step 624, if URL chain mapping is complete, the vPortal eCommerce session is ended in step 628. Otherwise, in step 626, if the user does not exit the vPortal session, then filtering of vPortal content continues, as described hereinabove, beginning with step 606. Otherwise, the vPortal eCommerce session is ended in step 628.

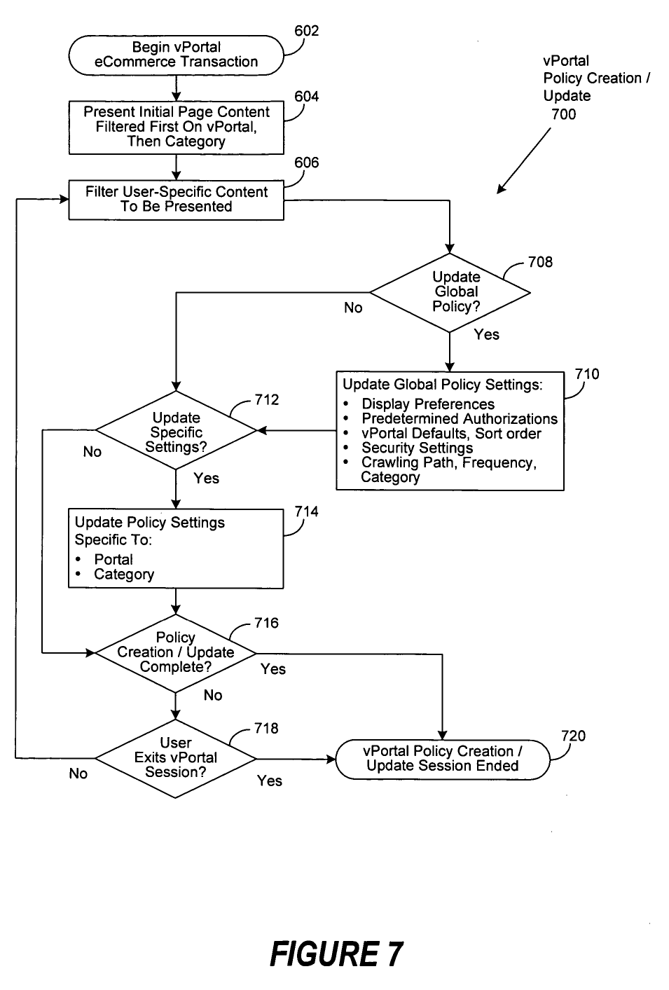

FIG. 7 is a flowchart illustration of an implementation of vPortal policy creation and/or update 600, for personalized presentation of eCommerce content, in accordance with one embodiment of the present invention. In step 602, an eCommerce transaction is initiated. In step 604, initial page content is presented to the user, filtered first on vPortal, and then by product category. In step 606, vPortal content is filtered to present pages of user-specific content. If, in step 708, global policies need to be updated, then the user, or an authorized party, can update the global pRegistry in step 710. For example, display preferences and/or predetermined authorizations for browse window, report window, pRegistry edit window can be updated for all users of the vPortal. Likewise, vPortal defaults, performance, sorting of URL lists, security settings, crawling parameters, update frequency, and new source page settings can also be updated. Those of skill in the art will understand that many such embodiments and variations of the invention are possible, including but not limited to those described hereinabove, which are by no means all inclusive.

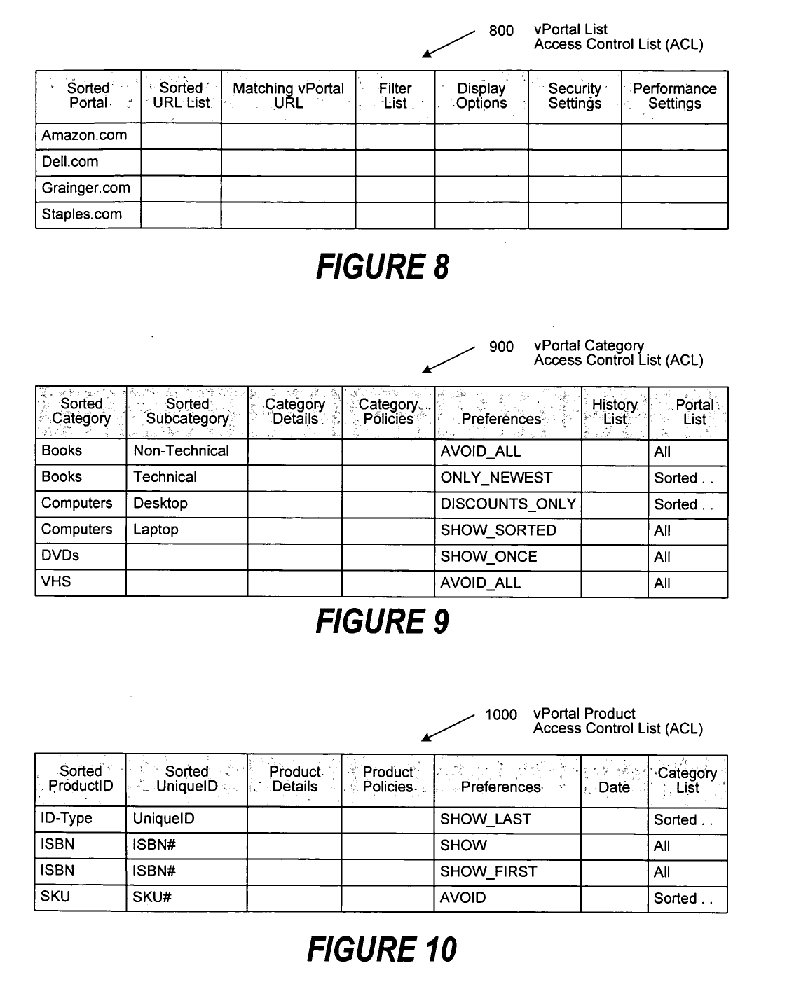

FIG. 8 is a generalized illustration of an implementation of a vPortal access control list (ACL) in accordance with an embodiment of the invention.

FIG. 9 is a generalized illustration of an implementation of a vPortal product category ACL in accordance with an embodiment of the invention.

FIG. 10 is a generalized illustration of an implementation of a vPortal product information ACL in accordance with an embodiment of the invention.

Skilled practitioners of the art will understand that the present invention as described in greater detail herein is not limited to a vPortal site, but could also be implemented as one or more cooperating users in a peer-to-peer relationship. Furthermore, vPortal and/or pRegistry implementation could be in the form of tables, compressed hash index, or any combination of data structures that implement the above inventions. Similarly, initially filtered pages have no dependencies on source page, content, target user(s) preferences, and/or predetermined authorizations. Likewise, page building or usage is not limited to online or manual, but could be off-line, pre-fetched, or automated.

Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation. At a minimum, the present invention provides a method and system for a virtual portal (vPortal), that can logically front-end and generate personalized presentations of eCommerce electronic (e.g., web portal) or paper-based (e.g., catalog) content, based on individual or group preferences and/or predetermined authorizations, through the implementation of a local portal registry (pRegistry), editable by a user or third party (e.g., corporate customer purchasing department). Furthermore, use of the present invention can also generate target content, mapped to a subset of available source content (e.g., web portal or hardcopy print), such that the target content can be a predetermined superset of individual user-selectable preferences and/or predetermined authorizations, including but not limited to eCommerce content, advertisements, content metrics, and reporting.

What is claimed is:

1. A system for providing a virtual portal to facilitate electronic commerce, comprising:
an information handling system operable to communicate with a communications network;
a local portal registry implemented by said information handling system, wherein said local portal registry is operable to generate predetermined presentations of electronic commerce content based on predetermined preferences.

2. The system of claim 1, wherein said predetermined presentation of electronic commerce content is based on individual preferences.

3. The system of claim 1, wherein said predetermined presentation of electronic commerce content is based on group preferences.

4. The system of claim 1, wherein said information handling system is operable to generate target content mapped to a subset of available source content.

5. The system of claim 4, wherein said target content is based on predetermined authorizations.

6. The system of claim 5, wherein said virtual portal is operable to used mappings to alter the content of said presentations of electronic commerce content.

7. The system of claim 6, wherein said mappings comprise changes to electronic commerce content stored in a cache.

8. The system of claim 6, wherein said mappings comprise just-in-time browsing of presented content.

9. The system of claim 6, wherein said mappings comprise order stats notifications.

10. The system of claim 6, wherein said mappings comprise usage and reporting metrics.

11. A method for providing a virtual portal to facilitate electronic commerce, comprising:
using an information handling system to communicate with a communications network;
using said information handling system to implement a local portal registry, wherein said local portal registry is operable to generate predetermined presentations of electronic commerce content based on predetermined preferences.

12. The method of claim 11, wherein said predetermined presentation of electronic commerce content is based on individual preferences.

13. The method of claim 11, wherein said predetermined presentation of electronic commerce content is based on group preferences.

14. The method of claim 11, wherein said information handling system is operable to generate target content mapped to a subset of available source content.

15. The method of claim 14, wherein said target content is based on predetermined authorizations.

16. The method of claim 15, wherein said virtual portal is operable to used mappings to alter the content of said presentations of electronic commerce content.

17. The method of claim 16, wherein said mappings comprise changes to electronic commerce content stored in a cache.

18. The method of claim 16, wherein said mappings comprise just-in-time browsing of presented content.

19. The method of claim 16, wherein said mappings comprise order stats notifications.

20. The method of claim 16, wherein said mappings comprise usage and reporting metrics.
